(19) United States
(12) Patent Application Publication
(10) Pub. No.: US 2024/0402743 A1
(43) Pub. Date: Dec. 5, 2024

(54) VOLTAGE REGULATOR

(71) Applicant: STMicroelectronics International N.V., Geneva (CH)

(72) Inventors: Helene ESCH, Seyssinet Pariset (FR); Jerome BOURGOIN, Saint Paul de Varces (FR); Eric FELTRIN, Grenoble (FR)

(73) Assignee: STMicroelectronics International N.V., Geneva (CH)

(21) Appl. No.: 18/678,767

(22) Filed: May 30, 2024

(30) Foreign Application Priority Data
Jun. 2, 2023 (FR) 2305578

(51) Int. Cl. G05F 1/575; G05F 1/573

(52) U.S. Cl. CPC G05F 1/575; G05F 1/573

(57) ABSTRACT

A voltage regulator has a first output is connected to a capacitive element. A current source is coupled between the first output and a first node receiving a power supply voltage. The current source delivers a first DC current in response to assertion of a first binary signal. A comparator asserts a second binary signal when a first voltage on the first output is lower than a set point voltage. A first circuit controls assertion of the first signal for a first fixed time period when the second binary signal is asserted.

### PRIORITY CLAIM

This application claims the priority benefit of French Application for U.S. Pat. No. 2,305,578, filed on Jun. 2, 2023, the content of which is hereby incorporated by reference in its entirety to the maximum extent allowable by law.

### TECHNICAL FIELD

The present disclosure generally concerns electronic circuits (for example, integrated electronic circuits) and, more particularly, voltage regulators.

### BACKGROUND

Voltage regulators are devices or circuits configured to deliver, based on a Direct Current (DC) power supply voltage, a regulated DC voltage having a value determined by a set point voltage or value. Many voltage regulators are known.

For example, known linear voltage regulators comprise a Metal Oxide Semiconductor (MOS) transistor coupling a node of application of the power supply voltage to a node for delivering the regulated voltage, and a comparator delivering a signal representative of the comparison of the value of the regulated voltage to that of the set point voltage or an error amplifier delivering an error signal representative of the error between the value of the regulated voltage and the set point value. The gate of the MOS transistor is then controlled from the signal delivered by the comparator or the amplifier, so that the regulated voltage is equal to the set point voltage. The transistor may have a P channel (PMOS) or an N channel (NMOS) configuration. As compared with a PMOS transistor, an NMOS transistor has a better power supply rejection ratio (PSRR). However, the implementation of the control of such an NMOS transistor requires previously knowing the static power consumption of the load. Now, this static power consumption depends on the PVT (“Process Voltage Temperature”) parameters, which raises an issue.

Further, the bandwidth of known linear voltage regulators decreases when it is attempted to decrease the static power consumption of the regulator, for example so that the regulator has a static power consumption lower than 5% of the average power consumption of the load which is, for example, smaller than or equal to approximately 10 u A at 27° C., or for example so that the regulator has a static power consumption lower than 200 nA, or even 100 nA for a load having a static power consumption in the order of 3 μA. This decrease of the bandwidth of the regulator is not desirable since it results in an increase of the variations of the regulated voltage around its set point value.

As an alternative example, known charge pump voltage regulators comprise switched capacitive elements. However, the provision of the capacitive elements of the charge pump makes these regulators bulky. Further, the capacitive elements are generally assembled outside of the chip comprising the switches of the charge pump, which makes the charge pump circuit more complex. This also requires increasing the number of input/output pads on the chip, which is not always possible.

As another alternative example, known voltage regulators comprise a switched-mode power supply (SMPS). However, a switched-mode power supply requires the provision of a coil, which makes the regulator bulky. Further, regulators of switched-mode power supply type are noise sources for the electronic systems to which they belong, which raises an issue when these systems comprise noise-sensitive circuits (or applications).

The three above examples of known voltage regulators all have disadvantages as concerns their power consumptions and/or their bulks and/or their regulation rapidities.

More generally, known voltage regulators have disadvantages.

There exists a need to overcome all or part of the disadvantages of known voltage regulators.

For example, there exists a need for a voltage regulator having a low static power consumption which has a low bulk and has a fast response.

For example, there exists a need for a voltage regulator enabling to limit an inrush current value on the output of the regulator.

For example, there exists a need for a regulator supplying information indicating an average value of the current consumed by a load connected to the output of the regulator.

### SUMMARY

An embodiment overcomes all or part of the disadvantages of known voltage regulators.

For example, an embodiment provides a voltage regulator having a low static power consumption, for example lower than 200 nA, or even than 100 nA, when the load that it powers is idle and has a static power consumption in the order of 3 μA, and which further has a low bulk and has a fast response.

An embodiment provides a voltage regulator comprising: a first output intended to be connected to a capacitive element; a current source coupling the first output to a first node configured to receive a power supply voltage, the current source being configured to deliver a first DC current only when a first binary signal is in its first binary state (asserted state); a comparator configured to deliver a second binary signal in its first binary state (asserted state) when a first voltage on the first output is lower than a set point voltage; and a first circuit configured to set the first signal to its first binary state for a first fixed time period when the second binary signal is in its first binary state.

According to an embodiment, the first time period is fixed and independent from the power supply voltage or fixed and determined by the power supply voltage.

According to an embodiment, the DC current has a fixed value independent from temperature.

According to an embodiment, the DC current has a value proportional to the absolute value of the temperature.

According to an embodiment, the regulator further comprises an inrush current regulation circuit configured, in an inrush current regulation phase, to periodically force the second binary signal to its second binary state (nonasserted state) for a second fixed time period.

According to an embodiment, the regulator comprises a measurement circuit configured to supply, at each end of a measurement period, a number of first time periods having begun during said measurement period.

According to an embodiment, the first time period and the current source are configured so that a quantity of charges supplied to the first output during each first time period is fixed for a given temperature value and power supply voltage value.

According to an embodiment, the first circuit comprises a second circuit adapted to delivering two control signals respectively to two switches of a switched-mode converter of pulse frequency modulation type, each first time period being determined based on at least one of the two control signals, preferably based on the two control signals.

According to an embodiment: the first output is further intended to be connected to a first terminal of an inductive element; the regulator comprises a second output intended to be connected to a second terminal of the inductive element, a first switch connected between the first node and the second output, and a second switch connected between the second output and a second node configured to receive a reference potential; the first circuit is configured, when the second binary signal is in its first binary state, to set a first control signal to its first binary state (asserted state) for a third time period, and then, at the end of the third time period, to set a second control signal to its first binary state (asserted state) for a fourth time period; the first circuit is further configured, in a first operating mode, to control an on state of the first switch when the first control signal is in its first binary state and an on state of the second switch when the second control signal is in its first binary state, and, in a second operating mode, to set the first signal to its first binary state as soon as one of the second and third signals is in its first binary state.

According to an embodiment, the third time period is fixed and determined by the power supply voltage, or fixed and independent from the power supply voltage, and the fourth time period is fixed and determined by the power supply voltage, or fixed and independent from the power supply voltage.

According to an embodiment, the first operating mode is of pulse frequency modulation type.

According to an embodiment, when the second binary signal is in its first binary state, the first circuit is configured to: generate a first voltage ramp, compare the first voltage ramp with a first threshold voltage, and set the first control signal to its first binary state from the beginning of the first voltage ramp until the first voltage ramp crosses the first threshold voltage; and generate a second voltage ramp when the first voltage ramp crosses the set point voltage, compare the second voltage ramp with a second threshold voltage, and set the second control signal to its first binary state from the beginning of the second voltage ramp until the second voltage ramp crosses the second threshold voltage.

One embodiment provides a device comprising the voltage regulator as described above, and a load connected to the first output of the regulator.

One embodiment provides a device comprising the voltage regulator as described above, a load connected to the first output of the regulator, and an inductive element connected between the first and second outputs of the regulator.

According to an embodiment, the device comprises an integrated circuit chip comprising the regulator, the inductive element being arranged outside of the chip.

According to an embodiment, the device further comprises a capacitive element connected to the first output of the regulator.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows an example of a voltage regulator of linear type;

FIG. 2 shows an example of a voltage regulator of switched-mode power supply type operating in pulse frequency modulation;

FIG. 3 shows an embodiment of a voltage regulator;

FIG. 4 shows an alternative embodiment of the regulator of FIG. 3;

FIG. 5 illustrates, in timing diagrams, an operating mode of the regulator of FIG. 4;

FIG. 6 shows another alternative embodiment of the regulator of FIG. 3;

FIG. 7 illustrates, in timing diagrams, an operating mode of the regulator of FIG. 6; and

FIG. 8 illustrates, in timing diagrams, another operating mode of the regulator of FIG. 6.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, . . . .

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

In the rest of the description, to simplify, when two nodes are at the same potential, these two nodes have the same reference and are described as if they corresponded to one and the same node, it being understood that, in practice, these two nodes may be distinct.

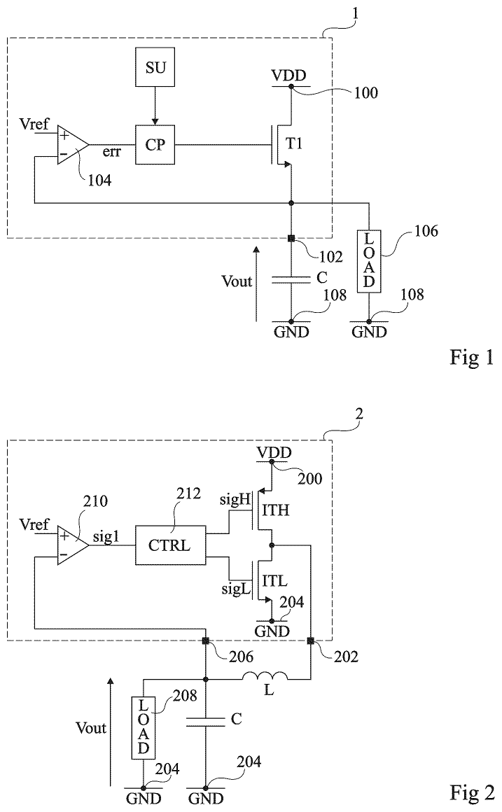

FIG. 1 shows an example of a linear voltage regulator 1.

Regulator 1 comprises a MOS transistor T1, in this example with an N channel, coupling a node 100 configured to receive a power supply voltage VDD, to an output 102 of regulator 1. The source of transistor T1 is connected to output 102, the drain of transistor T1 being connected to node 100. Regulator 1 is configured to deliver, on its output 102, a regulated voltage Vout having a value determined by a set point voltage Vref, for example a voltage Vout equal to voltage Vref.

For this purpose, in this example where transistor T1 has an N channel, regulator 1 comprises a comparator 104 configured to receive voltage Vref on its non-inverting input + and voltage Vout on its inverting input, and to deliver a signal err representative of the comparison of these two voltages with each other. It should be noted that, in an example where transistor T1 would have a P channel, comparator 104 is, preferably, replaced with an error amplifier 104 configured to receive voltage Vref on its non-inverting input + and voltage Vout on its inverting input, and to deliver a signal err representative of the comparison of these two voltages.

The gate of transistor T1 is controlled based on signal err, so that voltage Vout is equal to voltage Vref.

A load 106 (block “LOAD” in FIG. 1) is connected between output 102 and a node 108 configured to receive a reference potential GND, for example the ground. Load 106 is controlled by voltage Vout. A capacitive element C is connected to output 102. This capacitive element C enables, for example, to smooth variations of voltage Vout.

For example, this capacitive element C is a capacitor connected in parallel with load 106 between nodes 102 and 108 as shown in the example of FIG. 1. As another example not illustrated, this capacitive element C corresponds to the capacitance of load 106.

The use of an N-channel transistor T1 enables to suppress the voltage drop between node 100 and output 102 which would result from the use of a PMOS-type transistor T1 having its source connected to node 100 and its drain connected to output 102. The use of an N-channel transistor T1 also allows a better PSRR than with a P-channel transistor T1.

However, as illustrated in FIG. 1, the use of an NMOS-type transistor T1 implies providing a charge pump CP in regulator 1, between the output of error amplifier 104 and the gate of transistor T1. This further implies providing in regulator 1, a starting (i.e., start-up) circuit SU configured to precharge the charge pump, that is, to precharge the gate of transistor T1 to a value allowing the starting of regulator 1. This precharge value of the gate of transistor T1 is in practice determined based on the static power consumption of the load 106 which is connected to output 102. Now, as has been previously mentioned, the static power consumption of the load depends on the PVT parameter, whereby the configuration of circuit SU also depends on the PVT parameter, which is not desirable.

FIG. 2 shows an example of a voltage regulator 2 of switched-mode power supply type operating in pulse frequency modulation (PFM).

Switched-mode power supply 2 comprises a high side switch ITH, for example a PMOS transistor, connected between a node 200 configured to receive a power supply voltage VDD and an output 202 of regulator 2. Switched-mode power supply 2 further comprises a low side switch ITL, for example an NMOS transistor, connected between output 202 and a node 204 configured to receive a reference potential GND, for example the ground.

A coil L is connected between output 202 and an output 206 of regulator 2, coil L having a terminal connected to output 202 and a terminal connected to output 206.

Switched-mode power supply 2 is configured to deliver, on its output 206, a regulated voltage Vout to a load 208 (block “LOAD” in FIG. 2) connected to output 206 to be powered with voltage Vout. Load 208 is, for example, connected between output 206 and node 204 at reference potential GND. A capacitive element C is connected to output 206. This capacitive element C enables, for example, to smooth the variations of voltage Vout.

For example, this capacitive element C is a capacitive element connected in parallel with load 208 between nodes 206 and 204 as shown in the example of FIG. 2. As another example not illustrated, capacitive element C corresponds to the capacitance of load 106.

Regulator 2 is configured to deliver, on its output 206, voltage Vout regulated at a value determined by a set point voltage Vref, for example at a value equal to that of voltage Vref.

For this purpose, in this example where switched-mode power supply 2 operates in pulse frequency modulation, regulator 2 comprises a comparator 210 and a circuit 212 (block “CTRL” in FIG. 2).

Comparator 210 is configured to compare voltage Vout with voltage Vref. For example, comparator 210 receives voltage Vout on its inverting input − and voltage Vref on its non-inverting input +, and delivers an output signal sig1 in a first low binary state when voltage Vout is lower than voltage Vref, and in a second high binary state when voltage Vout is greater than voltage Vref. As an alternative example, comparator 210 receives voltage Vref on its inverting input − and voltage Vout on its non-inverting input +, and delivers an output signal sig1 in a first high binary state when voltage Vout is lower than voltage Vref, and in a second low binary state when voltage Vout is higher than voltage Vref.

Circuit 212 is configured to deliver two signals sigH and sigL for controlling the respective switches ITH and ITL. More particularly, when comparator 210 indicates that voltage Vout is lower than voltage Vref (signal sig1 in its first binary state), circuit 212 is configured to set signal sigH to its first binary state for a time period Ton, and then, at the end of time period Ton, to set signal sigL to its first binary state for a time period Toff. Outside of time periods Ton and Toff, circuit 212 is configured so that signal sigH is in its second binary state and signal sigL is in its second binary state. Circuit 212 is further configured so that signal sigL is in its second binary state during each time period Ton, and that signal sigH is in its first binary state during each time period Toff.

Regulator 2 is configured so that switch ITH is on when signal sigH is in its first binary state, and so that switch ITL is on when signal sigL is in its first binary state. Thus, switches ITH and ITL are respectively on and off during each time period Ton, respectively off and on during each time period Toff, and both off outside of time periods Ton and Toff.

Each of time periods Ton and Toff is, for example, fixed and determined by the power supply voltage, for example so that a maximum current in coil L at the end of each time period Ton, also called peak current, has a same value whatever the value of voltage VDD.

As an alternative example, each of time periods Ton and Toff is fixed and independent from voltage VDD.

A disadvantage of regulator 2 is that it requires coil L, which makes it bulky. Further, regulator 2 is a noise source, this noise for example resulting from the voltage variations across coil L occurring at least at the end of a time period Ton.

To overcome the disadvantages of known voltage regulators, there is here provided a voltage regulator where, when a regulated voltage Vout is lower than a set point voltage Vref, the regulator is configured to deliver a DC current I to an output of the regulator on which is available regulated voltage Vout, for a time period Tload, time period Tload being fixed and independent from the power supply voltage or fixed and determined by the power supply voltage, that is, fixed for a given power supply voltage value. A capacitive element is connected to the output of the regulator on which is available regulated voltage Vout, this capacitive element corresponding to a capacitive element connected to the output and/or to the capacitance of a load connected to the output.

Such a voltage regulator requires no coil, no starting circuit dependent on the PVT parameters, and no bulky capacitive elements such as the capacitive elements of a charge pump.

Advantageously, to control the controllable current source delivering DC current I only during each time period Tload, the voltage regulator may re-use known circuits for controlling high side and low side switches of a switched-mode power supply operating in pulse frequency modulation. Indeed, the provided regulator has an operation similar to that of a switched-mode power supply operating in pulse frequency modulation, with the difference that it requires no coil L. Of course, the present description is not limited to the case where the control circuit of the current source re-uses circuits for controlling high side and low side switches of a switched-mode power supply of PFM type. Indeed, fixed time period Tload (depending or not on the power supply voltage) may be generated by dedicated circuits re-using no circuits for controlling high side and low side switches of a switched-mode power supply of PFM type, for example by any circuits configured to generate pulses of duration Tload.

According to an embodiment, the value of current I delivered during each time period Tload is fixed.

According to an alternative embodiment, the current I delivered during each time period Tload has a value proportional to the absolute value of the temperature, or, in other words, is a Proportional To Absolute Temperature (PTAT) current. Thus, in the same way as the current leakages of the load, and thus the static power consumption thereof, increase as the temperature increases, the value of current I increases with temperature. This results in a better regulation of voltage Vout.

According to an embodiment, time period Tload and the value of current I are determined so that, for a given temperature value and a given value of the power supply voltage, at each time period Tload, a same quantity of charges is delivered by the regulator on its output on which is available regulated voltage Vout. In other words, the quantity of charges that the regulator delivers on its output for each time period Tload determines current I and time period Tload.

This quantity of charge delivered at each time period Tload determines the maximum current that the load can draw from the regulator while keeping the regulation of the output voltage of regulator at its set point value. Symmetrically speaking, the load which will be connected to the regulator and, in particular, the power consumption of this load, determine the quantity of charges that the regulator must deliver at each time period Tload to keep the regulation of the output voltage at its set point value, time period Tload and current I then being selected to obtain this quantity of charges.

As an example, when the regulator can operate in continuous injection and it is effectively operating in continuous injection, that is, when a new time period Tload starts from as soon as the end of each time period Tload, the regulator then is at its maximum current regulation limit. In other words, the regulator for example operates in continuous injection when the load that it powers consumes a current equal to the maximum regulated current that the regulator can deliver.

The voltage regulator provided herein is advantageously adapted to an implementation in low-power applications. For example, the voltage regulator provided herein as a static power consumption lower than 5% of the static power consumption of the load that it powers. For example, the voltage regulator provided herein has a static power consumption lower than 200 nA, or even than 100 nA, when it is sized to power a load having a static power consumption in the order of 3 μA.

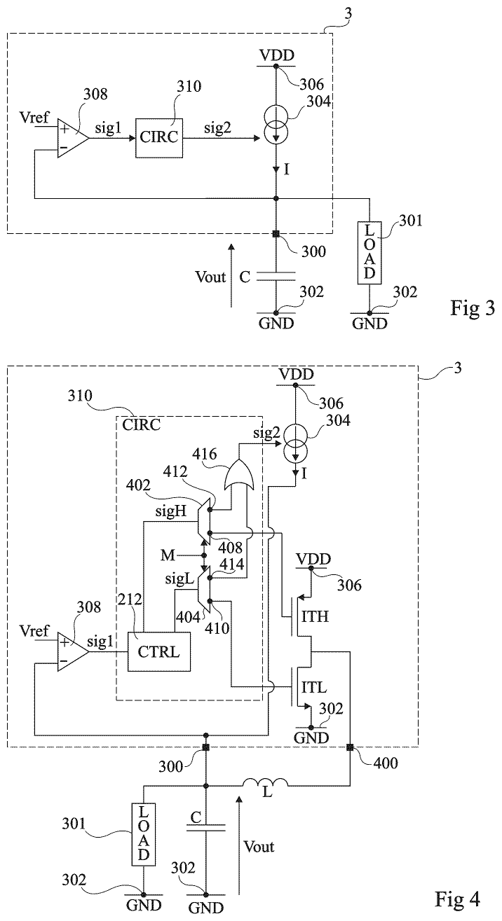

FIG. 3 shows an example of embodiment of such a voltage regulator, bearing reference 3 in this drawing.

Device 3 comprises an output 300 configured to deliver a regulated voltage Vout equal to a set point voltage Vref. A load 301 (block “LOAD” in FIG. 3) is intended to be connected to output 300 of regulator 3, to be powered with voltage Vout. In the example of FIG. 3, load 301 is shown as connected to output 300. For example, load 301 is connected between output 300 and a node 302 configured to receive a reference potential GND, for example the ground.

A capacitive element C is intended to be connected to output 300. As an example, this capacitive element C is a capacitance connected in parallel with load 301, between output 300 and node 302. As another example, this capacitive element C corresponds to the capacitance of load 302. As another example, this capacitive element corresponds to the capacitance equivalent to a capacitive element connected in parallel with load 301 and to the capacitance of load 301.

Circuit 3 further comprises a current source 304. Current source 304 couples output 300 to a node 306. For example, current source 304 has a terminal coupled, preferably connected, to node 306, and a terminal coupled, preferably connected, to output 300.

Node 306 is configured to receive a power supply voltage VDD of regulator 3. Voltage VDD is referenced to potential GND. Voltage VDD is, for example, positive.

Current source 304 is configured to deliver a DC current I, only when a binary signal sig2 is in its first (asserted) binary state. Thus, when signal sig2 is in its second (deasserted) binary state, current source 304 does not supply current I, or, in other words, supplies a zero current.

According to an embodiment, current I has a fixed value independent from temperature. According to another embodiment, current I has a value proportional to the absolute value of the temperature (PTAT).

Similarly to the regulator 2 described in relation with FIG. 2, the regulator 3 of FIG. 3 comprises a comparator 308 configured to compare the voltage Vout available on output 300 with set point voltage Vref.

For example, comparator 308 receives voltage Vout on its inverting input − and voltage Vref on its non-inverting input +, and delivers an output signal sig1 in a first low binary state when voltage Vout is smaller than voltage Vref, and in a second high binary state when voltage Vout is greater than voltage Vref. As an alternative example, comparator 308 receives voltage Vref on its inverting input − and voltage Vout on its non-inverting input +, and delivers an output signal sig1 in a first high binary state when voltage Vout is smaller than voltage Vref, and in a second low binary state when voltage Vout is higher than voltage Vref.

Regulator 3 further comprises a circuit 310 (block “CIRC” in FIG. 3). When comparator 308 indicates that voltage Vout is lower than voltage Vref, or, in other words, when signal sig1 is in its first binary state, circuit 310 is configured to set signal sig2 to its first binary state during time period Tload.

As a result, when voltage Vout becomes lower than voltage Vref, signal sig1 switches to its first binary state, which causes the setting to the first binary state of signal sig2 during time period Tload by circuit 310. The delivery of current I during time period Tload to element C tends to increase voltage Vout which approaches, or even exceeds, its set point value, that is, the value of voltage Vref.

According to an embodiment, circuit 310 comprises a circuit similar or identical to the circuit CTRL previously described in relation with FIG. 2. In other words, circuit 310 comprises a circuit configured to deliver two control signals sigH and sigL respectively to two switches ITH and ITL of a switched-mode power supply operating in pulse frequency modulation, although the switches ITH and ITL and the coil L of such a switched-mode power supply are not present in the regulator 3 of FIG. 3, and, more widely, in the device illustrated in FIG. 3.

In such an embodiment, time period Tload can then be determined by the time period Ton in the on state of switch ITH and/or the time period Toff in the on state of switch ITL.

For example, each time period Tload is then equal to (or one and the same as) a corresponding time period Ton. However, in this example, if voltage Vout is still lower than voltage Vref at the end of time period Tload, it must wait for the end of the next time period Toff to implement a new time period Tload, which may adversely affect the efficiency of the regulation of voltage Vout by regulator 3.

As an alternative example, each time period Tload is then equal to (or one and the same as) a corresponding time period Toff. However, in this example, the delivery of current I to output 300 after voltage Vout has become lower than voltage Vref will only occur after the end of the time period Ton preceding this time period Toff, which decreases the response time of regulator 3.

As another alternative example, each time period Tload corresponds to the total duration of a corresponding time period Ton and of the next time period Toff. As compared with the two above examples, this enables for regulator 3 to deliver current I for a time period Tload starting immediately after voltage Vout has become lower than voltage Vref, and, further, for a new time period Tload to be able to start immediately after the end of a current time period Tload if voltage Vout is lower than voltage Vref at the end of the current time period Tload. In other words, the regulator can then operate in continuous current injection.

Other implementations of circuit 310 are within the abilities of those skilled in the art based on the indications given in the present description, for example based on the functional indications given in the present application.

In particular, according to an embodiment, circuit 310 comprises no circuit similar or identical to the circuit CTRL previously described in relation with FIG. 2. In this case, circuit 310 is configured to deliver signal sig2 in its first binary state during time period Tload if voltage Vout is lower than voltage Vref, that is, if signal sig1 is in its first binary state. As an example, circuit 310 can then comprise a generator of pulses of duration Tload controlled by signal sig1, for example a pulse generator comprising a Schmitt trigger.

According to an embodiment, regulator 3 forms part of an integrated circuit chip and capacitive element C is arranged outside of the chip, the assembly of regulator 3 and of element C forming an electronic device. In this case, output 300 of regulator 3 correspond, for example, to an output terminal of the integrated circuit chip. Further, load 301 may form part of the same integrated circuit chip as the regulator, or, conversely, be arranged outside of the chip, the assembly of the regulator, of element C, and of charge 301 forming an electronic device.

FIG. 4 shows an example of alternative embodiment of the regulator 3 described in relation with FIG. 3.

In this alternative embodiment, regulator 3 is configured to operate selectively according to a first operating mode or a second operating mode. In other words, regulator 3 alternates between operating phases where it operates according to the first operating mode, and operating phases where regulator 3 operates according to the second operating mode.

In the second operating mode, regulator 3 operates in the way described in relation with FIG. 3. In other words, in the second operating mode, when voltage Vout is lower than voltage Vref, regulator 3 delivers current I to its output I for a time period Tload.

In the first operating mode, regulator 3 operates as a switched-mode power supply operating in pulse frequency modulation.

The alternative embodiment of FIG. 4 takes advantage of the fact that portions (or circuits) of regulator 3 can then be used in each of the first and second operating modes. As an example, this enables to have a compact regulator 3 that can operate alternately according to the first and second operating modes. As an alternative example, this enables for this same regulator 3 to be placed in an application where it only operates according to the first mode, or, conversely, in an application where it only operates according to the second mode.

The regulator 3 described herein in relation with FIG. 4 comprises many elements in common with the regulator 3 described in relation with FIG. 4, and only the differences between these two regulators are here highlighted.

More particularly, as compared with the regulator 3 described in relation with FIG. 3, the regulator 3 of FIG. 4 further comprises, similarly to the regulator 2 of FIG. 2, a high side switch ITH, for example a PMOS transistor, and a low side switch IT, for example an NMOS transistor.

Switch ITH couples the node 306 receiving voltage VDD to an output 400 of regulator 3, and switch ITL couples output 400 to the node 302 receiving reference potential GND.

Further, in FIG. 4, similarly to the regulator 2 of FIG. 2, output 300 of regulator 3 is intended to be connected to a terminal of a coil or of an inductive element L, output 400 of regulator 3 being intended to be connected to the other terminal of inductive element L. In the example of FIG. 4, element L is shown as connected between the outputs 300 and 400 of regulator 3. The presence of element L enables regulator 3 to be able to operate according to the first operating mode.

In the embodiment of FIG. 4, circuit 310 (block “CIRC” in FIG. 4), is configured, when comparator 308 indicates that voltage Vout (output 300) is lower than voltage Vref, to set a signal sigH to its first (asserted) binary state for a time period Ton, and then, at the end of time period Ton, to set a signal sigL to its first (asserted) binary state for a time period Toff. Time periods Ton and Toff are, for example, determined in the same way as in FIG. 2.

In the first operating mode, that is, when regulator 3 operates as a switched-mode power supply in pulse frequency modulation, regulator 3, and more particularly its circuit 310, are configured to set switch ITH to the on state when signal sigH is in its first binary state, and to set switch ITL to the on state when signal sigL is in its first binary state.

In the second operating mode, that is, when regulator 3 operates as described in relation with FIG. 3, regulator 3, and more particularly its circuit 310, are configured to set signal sig2 for controlling current source 304 to its first binary state only when signal sigH is in its first binary state, or, in a variant, only when signal sigL is in its first binary state, or in another variant, only when one or the other of signals sigH and sigL is in its first binary state.

According to an embodiment, a binary signal M of regulator 3, for example a signal M delivered to regulator 3 by another circuit, for example a microcontroller, determines the operating mode of regulator 3. For example, a first binary state of signal M corresponds to the first operating mode, and a second binary state of signal M corresponds to the second operating mode.

According to an embodiment, circuit 310 comprises the circuit 212 (block “CTRL” in FIG. 4) described in relation with FIG. 2. This circuit 212 delivers signals sigH and sigL based on signal sig1 in FIG. 4, in the same way as it would deliver signals sigH and sigL based on signal sig1 in FIG. 2. In this embodiment, based on signals sigH and sigL, circuit 310 is configured to control switches ITH and ITL as described in relation with FIG. 2 and to hold signal sig2 in its second binary state when regulator 3 operates according to the first operating mode, and to control source 304 as described in relation with FIG. 3 and to keep switches ITH and ITL off when regulator 3 operates according to the second operating mode.

For example, as shown in FIG. 4, circuit 310 comprises two routing circuits 402 and 403, for example two demultiplexers 402 and 404. Circuit 402, respectively 404, receives signals M and sigH, respectively M and sigL.

When signal M is in its first binary state (first operating mode control state), circuit 402, respectively 404, delivers signal sigH, respectively sigL, on its output 408, respectively 410, switch ITH, respectively ITL, being controlled from output 408, respectively 410. Output 408 of circuit 402, respectively output 410 of circuit 404, is coupled, preferably connected, to the gate of transistor ITH, respectively ITL. When signal M is in its second binary state (second operating mode), outputs 408 and 410 are such that switches ITH and ITL are off.

When signal M is in its second binary state (second operating mode control state), circuit 402, respectively 404, delivers signal sigH, respectively sigL, on its output 412, respectively 414. Outputs 412 and 414 are coupled, preferably connected, to inputs of a logic gate 416. Logic gate 416 and circuits 402 and 404 are configured to deliver signal sig2 based on signals sigH and sigL so that: signal sig2 is in its first binary state when signal M is in its second binary state and, in this example, one or the other of signals sigH and sigL is in its first binary state; signal sig2 is in its second binary state when signal M is in its second binary state and the two signals sigH and sigL are simultaneously in their second binary states; and signal sig2 is in its second binary state when signal M is in its first binary state.

In the above example, when, in the second operating mode, each duration Tload is equal to the total duration of a corresponding time period Ton and of a time period Toff following this time period Ton, and circuit 310 determines signal sig2 based on signals sigH and sigL.

In other examples, not illustrated, in the second operating mode, each duration Tload is equal to the duration of a corresponding time period Ton and circuit 310 determines signal sig2 only based on signal sigH. As an example, in this case, circuit 310 may be that illustrated in FIG. 4 where gate 416 is omitted and signal sig2 is directly available on output 412 of circuit 402.

In still other examples not illustrated, in the second operating mode, each duration Tload is equal to the duration of a corresponding time period Toff and circuit 310 determines signal sig2 only based on signal sigL. As an example, in this case, circuit 310 may be that illustrated in FIG. 4 where gate 416 is omitted and signal sig2 is directly available on output 414 of circuit 404.

As an example, the circuit 310 of the regulator 3 of FIG. 3 may correspond to the circuit 310 of the regulator 3 of FIG. 4 where circuits 402 and 404 are omitted.

Although there has been described in relation with FIG. 4 a specific implementation mode of circuit 310, those skilled in the art are capable of providing other implementations of circuit 410 based on the indications given in the present disclosure, for example based on the functional indications given in the present application.

According to an embodiment, the regulator 3 of FIG. 4 forms part of an integrated circuit chip, and element L is arranged outside of the chip. In this case, the outputs 300 and 400 of regulator 3 correspond, for example, to two input/output terminals of the integrated circuit chip. Further, load 301 may form part of the same integrated circuit chip as the regulator, or, conversely, be arranged outside of the chip.

The assembly of regulator 3, of elements C and L, and of load 301 forms an electronic device.

Although element C (FIGS. 3 and 4) and element L (FIG. 4) have been described hereabove as not forming part of regulator 3, in embodiments, this or these elements may form part of regulator 3.

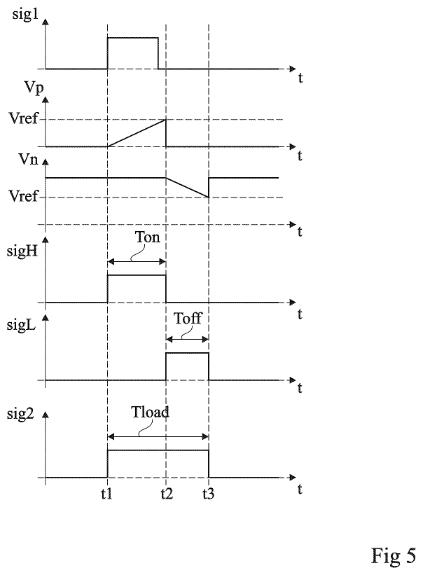

FIG. 5 illustrates, in timing diagrams, an example of operation of the regulator of FIG. 4. In this example, each time period Tload corresponds to the sum of a corresponding time period Ton and of the time period Toff following this time period Ton, or, in other words, the signal sig2 for controlling source 304 is determined based on the two signals sigH and sigL. In this example, circuit 310 is implemented in the way illustrated in FIG. 4. In this example, the first binary state of each of signals sig1, sigH, sigL, and sig2 corresponds to the high state of this signal, the second binary state corresponding to the low state of the signal.

In this embodiment, circuit 310 is configured, when signal sig1 indicates that voltage Vout is lower than voltage Vref, to: generate a voltage ramp Vp, compare ramp Vp with a first threshold voltage (in this example voltage Vref, although in other examples not illustrated the first threshold voltage may be different from voltage Vref), and set signal sigH to its first state from the beginning of ramp Vp until the first ramp crosses the first threshold voltage; and generate a voltage ramp Vn when ramp Vp crosses the first threshold voltage, compare ramp Vn with a second threshold voltage (in this example, voltage Vref although in other examples, not illustrated, the second threshold voltage may be different from voltage Vref and, for example, be different from the first threshold voltage), and set signal sigL to its first state from the beginning of ramp Vn until ramp Vn crosses the second threshold voltage.

In this example, ramp Vp is an upward sloping ramp and ramp Vn is a downward sloping ramp. However, in other examples, ramp Vp may be downward sloping and/or ramp Vn may be upward sloping.

Thus, in FIG. 5, at a time t1, voltage Vout (not illustrated) becomes lower than voltage Vref (not illustrated), whereby signal sig1 switches to its first binary state (high state in this example). Circuit 212 then generates a ramp Vp starting at time t1, and, at the same time, switches signal sigH to its first binary state (high state in this example). Time t1 thus marks the beginning of a corresponding time period Ton.

In FIG. 4, signal M (not illustrated) is in its second binary state, whereby regulator 3 operates according to the second mode. Thus, the switching of signal sigH to its first binary state at time t1 causes the switching of signal sig2 to its first binary state (high state in this example) at time t1.

From time t1, ramp Vp increases to cross the first threshold voltage (voltage Vref in this example) at a time t2 following time t1. Thus, at time t1, circuit 212 switches signal sigH to its second binary state (low state in this example). Further, circuit 212 then generates a ramp Vn starting at time t2, and, at the same time, switches signal sigL to its first binary state (high state in this example).

Time t2 thus marks the end of the time period Ton having started at time t1, and the beginning of a next time period Toff.

From time t2, ramp Vn decreases to cross the second threshold voltage (in this example voltage Vref) at a time t3 following time t2. Thus, at time t3, circuit 212 switches signal sigL to its second binary state (low state in this example).

Time t3 thus marks the end of the time period Toff having started at time t2.

Between times t1 and t3, one or the other of signals sigL and sigH is in its first binary state, these two signals sigL and sigH being in their second binary states before time t1 and after time t3. Thus, in this example, signal sig2 switches to its first binary state at time t1 and remains in its first binary state from time t1 to time t3 where its switches to its second binary state. In other words, time period Tload starts at time t1 and ends at time t3, and is equal to the sum of time period Ton (between times t1 and t2) and of time period Toff (between times t2 and t3). All along time period Tload, source 304 delivers current I to output 300 of the regulator.

In the example of FIG. 4, although this is not illustrated, voltage Vout increases from time t1 and becomes higher again than voltage Vref at a time between times t1 and t2, whereby signal sig1 switches to its second binary state at this same time.

In another example not illustrated, the operation described in relation with times t1, t2, and t3 is repeated from time t3 since voltage Vout is still lower than voltage Vref at this time t3, or, in other words, since signal sig1 is still in its first binary state at this time t3 (voltage Vout lower than voltage Vref).

According to an embodiment, the slope of each of ramps Vp and Vn is fixed (i.e., permanently set, non-changing) all along the operation of regulator 3, and, in particular, is independent from voltage VDD. In this case, each of time periods Ton, Toff, and Tload is fixed and independent from voltage VDD.

According to another embodiment, the slope of ramp Vp is proportional to 1/(VDD-Vout) so that time period Ton depends on voltage VDD and that the peak current in inductive element L when regulator 3 operates according to the first operating mode is constant and independent from voltage VDD.

Although there have been described in relation with FIG. 5 examples of operation of regulator 3 corresponding to the second operating mode of regulator 3, those skilled in the art will be capable based on the description made in relation with FIGS. 2 and 5, to deduce therefrom the operation of regulator 3 in the first operating mode. For example, referring to FIG. 5 again, in the first operating mode, switch ITH would have been set to the on state for time period Ton, after which switch ITL would have been set to the on state for time period Toff. Further, signal sig2 would have remained in its second binary state as long as regulator 3 operates according to the first operating mode.

Further, although there have been described in relation with FIG. 5 examples of operation of regulator 3 where each time period Tload corresponds to the sum (or succession) of a time period Ton and of a corresponding time period Tof, in other examples, each time period Tload corresponds to one time period Toff only, or to one time period Ton only.

Further, those skilled in the art will be capable of adapting the example of FIG. 5 where each of signals sig1, sigH, sigL, and sig2 is in the high state in its first binary state to examples where one or a plurality of these signals sig1, sigH, sigL, and sig2 is in the low state in its first binary state.

Simulations have shown that the regulator 3 of FIG. 3 and the regulator 3 of FIG. 4, when they operate according to the second mode, enable to obtain very low static power consumption values, for example between two consecutive time periods Tload. For example, the static power consumptions measured in simulations are lower than 5% of the average static power consumption of load 301. For example, for a load 301 having a low power consumption, that is, an average static power consumption lower than or equal to 3 μA, the static power consumptions measured for regulator 3 are lower than 200 nA, or even lower than 100 nA. As an example, the regulator 3 according to the alternative embodiment of FIG. 4 is implemented in an electronic system comprising noise-sensitive circuits or application. In this case, when the noise-sensitive circuit(s) or application(s) are not active, the first operating mode enables to take advantage of the high efficiency of regulator 3 operating in switched-mode power supply of PFM type, and, conversely, when the noise-sensitive circuit(s) or application(s) are active, the second operating mode enables to take advantage of the low noise of regulator 3 operating in injection of current I on load 301.

According to an embodiment, it would be desirable, in the regulator 3 of FIG. 3 and in the regulator 3 of FIG. 4, at least when the latter operates according to the second operating mode, to regulate the inrush current that a load 301 draws from the regulator output 300, for example at the starting of this regulator.

According to another embodiment, combined or not with the above embodiment, it would be desirable, in the regulator 3 of FIG. 3 and in the regulator 3 of FIG. 4 operating according to the second operating mode, to measure the average current Im drawn by a load 301 connected to output 300, that is, to obtain a signal having a value indicating the value of this average current Im.

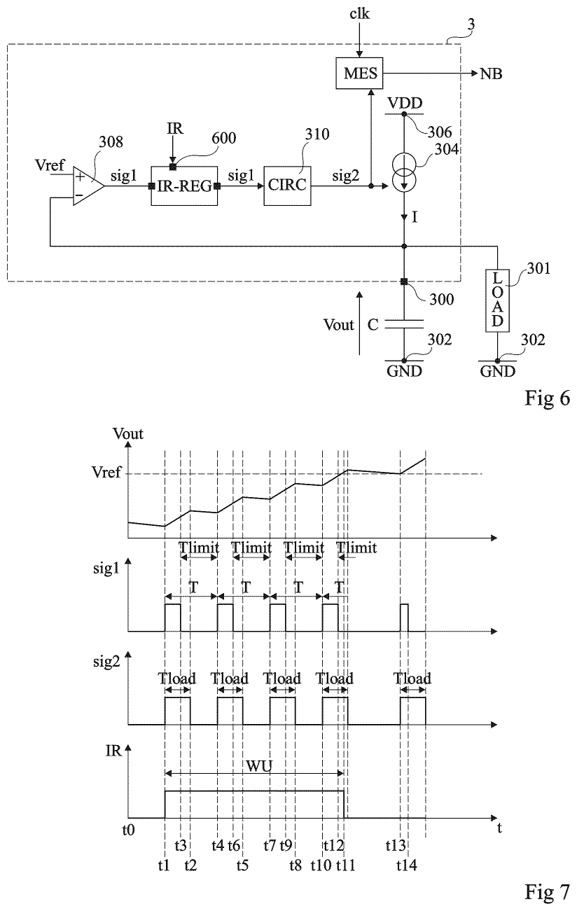

FIG. 6 shows another alternative embodiment of the regulator 3 of FIG. 3.

The regulator 3 of FIG. 6 comprises many elements in common with the regulator 3 of FIG. 3, and only the differences between these two regulators are here highlighted. More particularly, as compared with the regulator 3 of FIG. 3, the regulator 3 of FIG. 6 further comprises an inrush current regulation circuit IR-REG and a circuit MES for measuring average current Im.

Circuit IR-REG, shown in the form of a block in FIG. 6, is configured to force binary signal sig1 to its second binary state during a fixed and periodic time period Tlimit when the regulator is in an operating phase WU. Phase WU is an inrush current regulation phase. Circuit IR-REG is, for example, configured to transmit signal sig1 from the output of comparator 308 to circuit 310, by forcing it to its second binary state during periodic time period Tlimit when the regulator is in operating phase WU.

As an example, the regulator is in an operating phase WU when the average current I drawn by the load 301 connected to the output 300 of regulator 3 would be too high in the absence of a regulation of the inrush current. In other words, the phase WU corresponds to an operating phase where it is desirable to limit the value of the current supplied by the regulator to the load. As an example, this operating phase WU corresponding to a startup (or starting) phase of regulator 3, for example when regulator 3 is switched from an off state or from a standby state to an on state where load 301 is to be powered with voltage Vout regulated at set point value Vref. For example, at the beginning of each operating phase WU, voltage Vout is lower than voltage Vout, and is for example zero.

As an example, circuit IR-REG receives an indication of the beginning and of the end of operating phase WU.

As an example, a binary signal IR is in its first binary state for the entire duration of phase WU, and has its second binary state otherwise. In other words, circuit IR-REG is configured, when signal IR is in its first binary state, to periodically force signal sig1 to its second binary state during fixed time period Tlimit. Circuit IR-REG for example receives signal IR, for example on an input 600. Circuit IR-REG is, for example, configured to transmit signal sig1 from the output of comparator 308 to circuit 310, by forcing it to its second binary state during periodic time period Tlimit when binary signal IR is in its first binary state.

As an example, signal IR is delivered by a circuit, not shown in FIG. 6, which circuit may be external to regulator 3.

According to an embodiment, each operating phase WU ends when voltage Vout reaches its set point value Vref, and the end of phase WU causes, for example, the switching of signal IR to its second binary state. As a variant, each operating phase WU has a fixed duration identical for all operating phases WU. However, it is preferable for each phase WU to end when voltage Vout reaches its set point value Vref since this enables to take into account the variations of certain values with respect to corresponding typical values, such as for example variations of the value of capacitance C.

According to an embodiment, circuit IR-REG receives the output signal sig1 of comparator 308 and transmits this signal sig1 to circuit 310: without modifying it when the regulator is not in a phase WU, for example when signal IR is in its second binary state, and by forcing it to a second binary state during periodic time period Tlimit when the regulator is in a phase WU, for example when signal IR is in its first binary state.

As an example, although this is not detailed in FIG. 6, circuit IR-REG comprises a switch receiving the output signal sig1 of comparator 308, and a signal (for example a voltage) corresponding to the second binary state of signal sig1, and delivering signal sig1 to circuit 310. Circuit IR-REG further comprises a circuit configured to deliver a signal for controlling this switch. This switch control circuit recieves an indication of the beginning and of the end of a phase WU. For example, this control circuit receives signal IR. When the regulator is not in a phase WU, for example, when signal IR is in its second binary state, the switch transmits on its output, and thus to circuit 310, the signal sig1 that it receives from comparator 308 without modifying it. However, when the regulator is in a phase WU, for example when signal IR is in its first binary state, the switch control signal is configured so that the switch output receives, during each periodic duration Tlimit, the signal corresponding to the second binary state of signal sig1, and the output signal sig1 of comparator 308 outside of these time periods Tlimit.

As another example, although this is not detailed in FIG. 6, circuit IR-REG comprises a switch configured to pull signal sig1 to its second binary state when this switch is in the on state, and to avoid modifying the state of signal sig1 when this switch is in the off state. For example, when the second binary state of signal sig1 corresponds to a zero voltage, this switch is connected between the output of comparator 308 and node 302. As an alternative example, when the second binary state of signal sig1 corresponds to voltage VDD, this switch is connected between the output of comparator 308 and node 306. Further, circuit IR-REG comprises a switch for controlling this switch configured to control the off state of the switch when the regulator is not in a phase WU, for example, when signal IR is in its second binary state, and to control the on state of the switch during each periodic time period Tlimit when the regulator is in a phase WU, for example when signal IR is in its first binary state.

As an example, the signal for controlling the switch of the first above-described example, or the switch of the second above-described example, is a binary signal which is held in its first binary state when signal IR is in its second binary state, and which is set to its second binary state during time period Tlimit, periodically, when signal IR is in its first binary state. Thus, when signal IR is in its first binary state, at each period of the control signal, the control signal is in its second binary state during time period Tlimit and in its first binary state for the rest of the period. In this case, the second binary state of the control signal forces the second binary state of signal sig1 delivered to circuit 310.

As an example, when the regulator is in a phase WU, for example, when signal IR is in its first binary state, the period T with which circuit IR-REG periodically forces signal sig1 to its second binary state during time period Tlimit is greater than time period Tload.

As an example, during each phase WU, each beginning of a period T is synchronized with the beginning of a time period Tload. Thus, when the regulator is in a phase WU, the circuit transmits without modifying it the signal sig1 that it receives from comparator 308, which triggers the beginning of a time period Tload. The beginning of this time period Tload causes the beginning of a period T during which the signal sig1 delivered by circuit IR-REG to circuit 310 will be forced to its second binary state during time period Tlimit. In this case, the end of time period Tlimit also marks the end of this period T. In this case, period T may have a duration equal to duration Tlimit.

Of course, the implementation of circuit IR-REG is not limited to the two above-described examples of implementation, and those skilled in the art will be capable of providing many other examples of implementation of this circuit IR-REG based on the above functional description of circuit IR-REG.

Preferably, when regulator 3 comprises a circuit IR-REG such as described hereabove, current source 304 is configured to supply a current I having a temperature-constant value. This enables the management of the inrush current during each phase WU not to be dependent on temperature. However, the provision of a current I having a value proportional to absolute temperature (PTAT) or having a value complementary to absolute temperature (CTAT) remains possible, but the inrush current management will be less accurate.

Preferably, when regulator 3 comprises a circuit IR-REG such as described hereabove, preferably duration Tload is fixed and independent from voltage VDD. This enables the inrush current management during each phase WU not to be dependent on voltage VDD. However, having a fixed duration Tload determined by the value of voltage VDD remains possible, but the inrush current management will then be less accurate.

FIG. 7 illustrates, in timing diagrams, an example of operation of regulator 3. More particularly, FIG. 7 illustrates the time variation of voltage Vout, of the signal sig1 received by circuit 310, that is, the signal sig1 available at the output of circuit IR-REG, of the signal sig2 for controlling current source 304, and of signal IR.

In this example, the first binary state of signal sig1 is the high state of signal sig1, the first binary state of signal sig2 is the high state of signal sig2, and the first binary state of signal IR is the high state.

At a time t0, as an example, regulator 3 is off or at standby. Voltage Vout is, for example lower than set point Vref, and decreases. Signals sig1 and sig2 are thus in their second binary states (low states in the example of FIG. 7). As an example, signal IR is in its second binary state (low state in the example of FIG. 7).

At a next time t1, regulator 3 is started and a wake-up phase WU begins. Signal IR is thus switched to its first binary state (high state in the example of FIG. 7). Time t1 also marks the beginning of a period T of repetition of time period Tlimit.

At time t1, voltage Vout being lower than voltage Vref, the output of comparator 308 is in its second binary state. In this example, for each period T, circuit IR-REG is configured to transmit to circuit 310 the signal sig1 that it receives from comparator 308 without modifying it at the beginning of period T, and then to force this signal sig1 to its second binary state during time period Tlimit ending with period T. Thus, from time t1, the signal sig1 received by circuit 310 is in its first binary state (high state in the example of FIG. 7). The first binary state of signal sig1 causes the setting to the first binary state of signal sig2 (high state in the example of FIG. 7) by circuit 310, for a time period Tload ending at a next time t2.

During this time period Tload, current source 304 supplies non-zero current I to load 301, and voltage Vout increases.

At time t2 of end of period Tload, voltage Vout is still lower than voltage Vref, and the output of comparator 308 is still in its first binary state. However, for the period T having started at time t1, time period Tlimit has started at a time t3 between times t1 and t2. Thus, from time t3 and until the end of this period Tlimit at a time t4 subsequent to time t2, circuit IR-REG forces the signal sig1 received by circuit 310 to its second binary state (low state in the example of FIG. 7). As a result, between times t3 and t4, although voltage Vout is lower than voltage Vref, circuit 310 does not switch signal sig2 to its second binary state during a time period Tload. No current I is supplied to load 301 by current source 304 and voltage Vout decreases.

Time t4 marks the end of the current period T, and thus, in this example, the end of the corresponding period Tlimit, and the beginning of a new period T. At time t4, voltage Vout is lower than voltage Vref and the output of comparator 308 is thus in its first binary state. In this example, at the beginning of this new period T, circuit IR-REG transmits to circuit 310 the signal sig1 that it receives from comparator 308, whereby, from time t4, the signal sig1 received by circuit 310 is in its first binary state (high state in the example of FIG. 7).

The operation described in relation with successive times t1, t2, t3, and t4 for the period T beginning at time t1 is then repeated for the successive times t4, t6, t5, and t7 shown in FIG. 7, during the period T beginning at time t4, and then again for successive times t7, t9, t8, and t10, for a period T beginning at time t7.

Similarly to what has been described hereabove, a new period T begins at time t10, while voltage Vout is still lower than voltage Vref, whereby the output of comparator 308 is in its first binary state and circuit IR-REG thus transmits signal sig1 in its first binary state to circuit 310. Circuit 310 then switches signal sig2 to its first binary state (the high state in the example of FIG. 7) and current source 304 supplies current I to load 301, whereby voltage Vout increases.

At a next time t11, during this time period Tload, voltage Vout becomes higher than voltage Vref, which marks, in this example, the end of phase WU. The end of starting phase WU corresponds to the switching of signal IR to its second binary state (the low state in the example of FIG. 7). Thus, although a period T has begun at time t11, and a time period Tlimit corresponding to this period T has begun at a time t12 between times t10 and t11, this period T and this time period Tlimit end, in anticipated fashion, at time t11.

From time t11, regulator 3 operates as described in relation with FIG. 3. For example, at a next time t13, voltage Vout becomes lower than voltage Vref, which causes the switching of the output of comparator 308 to its first binary state. Since signal IR is in its second binary state, the output of comparator 308 is transmitted with no modification to circuit 310 by circuit IR-REG, and circuit 310 thus receives signal sig1 in its first binary state (high state in the example of FIG. 7). This causes the beginning of a period Tload where signal sig2 is in its first binary state (high state in the example of FIG. 7), current source 304 delivers current I, and voltage Vout increases.

During this time period Tload, voltage Vout becomes higher again than voltage Vref at a time t14 subsequent to time t13, which causes the switching of the output of comparator 308 to its second binary state. Since signal IR is in its second binary state, the output of comparator 308 is transmitted with modification to circuit 310 by circuit IR-REG, and the signal sig1 received by circuit 310 switches to its second binary state (low state in the example of FIG. 7) at time t14.

Those skilled in the art will be capable of adapting the above-described example of operation to the case where phase WU has a fixed duration and does not end when voltage Vout becomes greater than voltage Vref and/or to the case where, for each period T of repetition of time period Tlimit, time period Tlimit begins with the beginning of period T and/or to the case where each period T is synchronized with the beginning of a corresponding time period Tload.

Returning to FIG. 6, in this variant, regulator 3 further comprises circuit MES for measuring average current Im as previously indicated.

Circuit MES is configured to deliver, at each end of a measurement period Tmes, a number NB of time periods Tload having started during this period Tmes. Preferably, measurement period Tmes is periodically repeated. For example, at each end of a period Tmes, a new period Tmes begins.

Since the quantity of charges injected onto the output 300 of regulator 3 during each time period Tload is fixed, at least for a given voltage VDD and a given temperature, the number of time periods Tload per measurement period Tmes is representative of the average current Im supplied to output 300 during this period Tmes.

Circuit MES thus receives signal sig2. Indeed, each switching of signal sig2 to its first binary state corresponds to the beginning of a corresponding time period Tload. Further, the circuit delivers number NB, for example in the form of a digital signal over a plurality of bits. As an example, signal NB corresponds to the output signal COUNT of a counter of circuit MES, this counter being reset at each beginning of a period Tmes, and incremented at each beginning of a time period Tload. As an example, circuit MES may comprise a register configured to receive the counter output COUNT, and to deliver signal NB, this register updating signal NB based on the output COUNT of the counter at each end of a period Tmes.

Preferably, when regulator 3 comprises a circuit MES such as described hereabove, current source 304 is configured to supply a current I having a temperature-constant value. This enables the value of the average current deduced, calculated, or determined based on the number of time periods Tload per measurement period Tmes to be more accurate. However, the provision of a current I having a value proportional to absolute temperature (PTAT) or having a value complementary to absolute temperature (CTAT) remains possible, but the error on the value of the average current deduced, calculated, or determined based on the number of time periods Tload per measurement period Tmes will depend on temperature, unless a correction of the value of the average current is implemented according to temperature.

Preferably, when regulator 3 comprises a circuit IR-REG such as described hereabove, preferably time period Tload is fixed and independent from voltage VDD. This enables the value of the average current deduced, calculated, or determined based on the number of time periods Tload per measurement period Tmes to be more accurate. However, having a fixed duration Tload determined by the value of voltage VDD remains possible, but the error on the value of the average current deduced, calculated, or determined based on the number of time periods Tload per measurement period Tmes will depend on temperature, unless a correction of the value of the average current is implemented according to voltage VDD.

As an example, the circuit receives a periodic signal clk of period Tmes. Time period Tmes is longer than time period Tload.

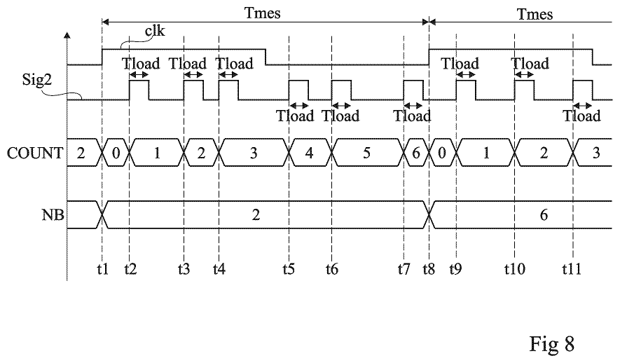

FIG. 8 illustrates, in timing diagrams, an example of operation of circuit MES. In this example, circuit MES comprises a counter and a flip-flop as described hereabove as an example.

More particularly, FIG. 8 illustrates the variation, as a function of time t, of signal clk of period Tmes, of signal sig2, of the output Count of the counter, and of the output signal NB of the register.

At a time t0, signal clk switches to a state, for example the high state, which marks the beginning of a period Tmes. At time to, signal NB is updated with the value of signal COUNT at time t0, for example 2 in the example of FIG. 8, and output COUNT is reset to 0.

During the period Tmes which begins at time t1, time periods Tload start at respective successive times t2, t3, t4, t5, t6, and t7. Thus, output COUNT is incremented by one unit at each of times t2, t3, t4, t5, 6, and t7.

Between times t4 and t5, signal clk switches to another state, for example the low state, and then at a time t8 subsequent to time t7, signal clk switches back to its high state. This switching marks the end of the current period Tmes and the beginning of a new period Tmes. Thus, at time t8, the register output NB is updated with the output value COUNT of the register, that is, 6 in the example of FIG. 8, and the register output COUNT is reset to 0.

During the period Tmes which begins at time t8, time periods Tload start at respective successive times t9, t10, and t11. Thus, output COUNT is incremented by one unit at each of times t9, t8, and t11.

Referring again to FIG. 6, although the regulator 3 of the example of variant of FIG. 6 comprises both circuit MES and circuit IR-REG, in other variants not shown, regulator 3 may comprise circuit MES and be deprived of circuit IR-REG, or, conversely, be deprived of circuit MES and comprise circuit IR-REG.

Further, although the operation of circuits MES and IR-REG in a regulator 3 of the type of that described in relation with FIG. 3 has been illustrated, those skilled in the art will be capable of providing circuit MES and/or circuit IR-REG in a regulator 3 of the type of that described in relation with FIG. 4.

Further, although examples of implementations of circuits MES and IR-REG have been described, those skilled in the art will be capable of providing other examples of implementations of these circuits based on the above functional description of these circuits. In particular, although a circuit MES which counts the number of time periods Tload per measurement period Tmes based on the switching of signal sig2 has been described, in the case of a regulator of the type of that of FIG. 4, circuit MES may count the number of time periods Tload per period Tmes based on the switching of signal sigH or of signal sigL, which may be advantageous when continuous injection is possible.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove. In particular, regarding the implementation of circuit 310, the latter is not limited to an implementation comprising circuit 212, and those skilled in the art are capable of providing other implementations of this circuit 310 based on the functional indications given hereabove. For example, time periods Ton and Toff may be generated otherwise than based on respective ramps Vp and Vn. More generally, the present disclosure is not limited to the case of a circuit 310 implemented based on a circuit 212 configured to control high side and low side switches in a switched-mode power supply operating in PFM.

1. A voltage regulator, comprising:
a first output intended to be connected to a capacitive element;
a current source coupled between the first output and a first node configured to receive a power supply voltage, the current source being configured to deliver a first DC current to the first output only in response to assertion of a first binary signal;
a comparator configured to deliver a second binary signal that is in an asserted state when a first voltage on the first output is lower than a set point voltage; and
a first circuit configured to assert the first binary signal for a first fixed time period when the second binary signal is in the asserted state.

2. The voltage regulator according to claim 1, wherein the first time period is fixed and independent from the power supply voltage.

3. The voltage regulator according to claim 1, wherein the first time period is determined by the power supply voltage.

4. The voltage regulator according to claim 1, wherein the DC current has a fixed value independent from temperature.

5. The voltage regulator according to claim 1, wherein the DC current has a value proportional to the absolute value of the temperature.

6. The voltage regulator according to claim 1, wherein the regulator further comprises an inrush current regulation circuit configured, in an inrush current regulation phase, to periodically force the second binary signal to a nonasserted state for a second fixed time period.

7. The voltage regulator according to claim 1, wherein the regulator comprises a measurement circuit configured to supply, at an end of each measurement period, a number of first time periods having begun during said measurement period.

8. The voltage regulator according to claim 1, wherein the first time period and the current source are configured so that a quantity of charges supplied to the first output during each first time period is set dependent on a given temperature value and power supply voltage value.

9. The voltage regulator according to claim 1, wherein the first circuit comprises a second circuit configured to deliver first and second control signals respectively to first and second switches of a switched-mode converter of pulse frequency modulation type, each first time period being determined based on at least one of the first and second control signals.

10. The voltage regulator according to claim 9, wherein each first time period is determined based on both of the first and second control signals.

11. The voltage regulator according to claim 1:
wherein the first output is further intended to be connected to a first terminal of an inductive element;
further comprising:
a second output intended to be connected to a second terminal of the inductive element;
a first switch connected between the first node and the second output; and
a second switch connected between the second output and a second node configured to receive a reference potential;
wherein the first circuit is configured, when the second binary signal is in the asserted state, to assert a first control signal for a third time period, and then, at the end of the third time period, to assert a second control signal for a fourth time period;
wherein the first circuit is further configured, in a first operating mode, to control an on state of the first switch when the first control signal is in the asserted state and control an on state of the second switch when the second control signal is in the asserted state, and, in a second operating mode, to set the first binary signal to the asserted state in response to either assertion of the first binary signal or the second control signal being in the asserted state.

12. The voltage regulator according to claim 11, wherein the third time period is fixed and determined by the power supply voltage.

13. The voltage regulator according to claim 11, wherein the third time period is fixed and independent from the power supply voltage.

14. The voltage regulator according to claim 11, wherein the fourth time period is fixed and determined by the power supply voltage.

15. The voltage regulator according to claim 11, wherein the fourth time period is fixed and independent from the power supply voltage.

16. The voltage regulator according to claim 11, wherein the first operating mode is of pulse frequency modulation type.

17. The voltage regulator according to claim 11, wherein, when the second binary signal is in the asserted state, the first circuit is configured to:
generate a first voltage ramp, compare the first voltage ramp with a first threshold voltage, and assert the first control signal for a period of time from a beginning of the first voltage ramp until the first voltage ramp crosses the first threshold voltage; and
generate a second voltage ramp when the first voltage ramp crosses the first threshold voltage, compare the second voltage ramp with a second threshold voltage, and set the second control signal to the asserted state for a period of time from a beginning of the second voltage ramp until the second voltage ramp crosses the second threshold voltage.

18. A device, comprising:
the voltage regulator according to claim 1; and
a load connected to the first output of the regulator.

19. The device according to claim 18, wherein the device further comprises a capacitive element connected to the first output of the regulator.

20. A device, comprising:
the voltage regulator according to claim 11;
a load connected to the first output of the voltage regulator; and
an inductive element connected between the first and second outputs of the voltage regulator.

21. The device according to claim 20, wherein the device comprises an integrated circuit chip comprising the voltage regulator, wherein the inductive element is arranged outside of the integrated circuit chip.
